(19) United States
(12) Patent Application Publication
(10) Pub. No.: US 2015/0045001 A1
(43) Pub. Date: Feb. 12, 2015

(54) ELECTRONIC DEVICE HAVING TOUCH SCREEN AND OPERATION METHOD THEREOF

(71) Applicant: Samsung Electronics Co., Ltd., Gyeonggi-do (KR)

(72) Inventors: Byongyun Song, Daegu (KR); Gyucheol Choi, Gyeongsangbuk-do (KR)

(21) Appl. No.: 14/453,485

(22) Filed: Aug. 6, 2014

(30) Foreign Application Priority Data
Aug. 6, 2013 (KR) 10-2013-0093078

(51) Int. Cl. G06F 3/01; G06F 3/0484; H04M 1/663; H04M 1/67; G06F 21/36

(52) U.S. Cl. CPC G06F 3/017; H04M 1/67; G06F 21/36; H04M 1/663; G06F 3/0484; H04M 2250/22
USPC 455/411; 715/863

(57) ABSTRACT

A method for operating a lock screen in an electronic device includes displaying a two-dimensional geometric shape on a screen, receiving at least one user input that crosses and divides the two-dimensional geometric shape into multiple portions, receiving touches on each of the multiple portions in a sequence, and comparing the sequence of the touches on each of the multiple portions with a pre-defined sequence. An electronic device for operating a lock screen includes a touch screen configured to display a two-dimensional geometric shape on a screen, a controller configured to detect at least one user input that crosses and divides the two-dimensional geometric shape into multiple portions, detect touches on each of the multiple portions in a sequence, and compare the sequence of the touches on each of the multiple portions with a pre-defined sequence. Other embodiments are also disclosed.

### CROSS-REFERENCE TO RELATED APPLICATION AND CLAIM OF PRIORITY

The present application is related to and claims the benefit under 35 U.S.C. §119(a) of a Korean patent application No. 10-2013-0093078 filed on Aug. 6, 2013 in the Korean Intellectual Property Office, the entire disclosure of which is hereby incorporated by reference.

### TECHNICAL FIELD

The present disclosure relates to an electronic device having a touch screen. More particularly, embodiments of the present disclosure relate to an electronic device having a lock screen function and further to a method for operating the lock screen function.

### BACKGROUND

Recently electronic devices having a touch screen, especially mobile devices, have offered a function to lock the touch screen, namely a lock screen function. This function is to prevent the electronic device from recognizing any unintended touch input.

A lock state of the touch screen is different from an inactivated state of the touch screen. While the inactivated state disallows all touch inputs, the lock state allows only a user's input for unlocking the lock screen since the touch screen is still activated.

In order to unlock the lock screen, a user may enter a predefined pattern, password, pin number, or the like by referring to a guide displayed on the touch screen.

FIGS. 1A to 1C are example screens showing typical guides used to unlock the lock screen.

FIG. 1A shows a pattern input guide for unlocking the lock screen. In this case, the electronic device receives a touch input passing through four or more points among nine points displayed on the screen, and determines whether the received touch input is identical with a predefined unlocking pattern.

FIG. 1B shows a password input guide for unlocking the lock screen. In this case, the electronic device receives a touch input from alphabetic keys displayed on the screen, and determines whether the received touch input is identical with a predefined password.

FIG. 1C shows a pin number input guide for unlocking the lock screen. In this case, the electronic device receives a touch input from numeral keys displayed on the screen, and determines whether the received touch input is identical with a predefined pin number.

However, according to the above-mentioned typical techniques to display a guide for unlocking the lock screen, a user can perceive the displayed guide through the sense of sight only. Therefore, a user has to see the screen and perform an exact input at a predetermined position in conformity with the guide displayed on the screen. Unfortunately, this may cause inconvenience to a user.

Accordingly, there is a need for a new technique to effectively unlock the lock screen in electronic devices having a touch screen or any other touch-sensitive input mechanism.

### SUMMARY

A method for operating a lock screen in an electronic device includes displaying a two-dimensional geometric shape on a screen, receiving at least one user input that crosses and divides the two-dimensional geometric shape into multiple portions, receiving touches on each of the multiple portions in a sequence, and comparing the sequence of the touches on each of the multiple portions with a pre-defined sequence.

In some embodiments, the method includes unlocking a lock screen when the sequence of the touches on each of the multiple portions matches a predefined sequence.

In some embodiments, the two-dimensional geometric shape is one of a circle, a bar, a rectangular, an oval, an ellipse, or an informal two-dimensional shape.

In some embodiments, the method includes comparing a division structure of the two-dimensional geometric shape into multiple portions with a predefined division structure.

In some embodiments, the method includes storing the sequence of the touches on each of the multiple portions for a password.

In some embodiments, each multiple portion includes a point on the respective portion.

In some embodiments, the two-dimensional geometric shape is divided into three portions by two drags.

In some embodiments, at least one of the multiple portions is touched more than one.

In some embodiments, a portion of the multiple portions, being touched is displayed distinctively.

In some embodiments, the user input is a drag.

An electronic device for operating a lock screen includes a touch screen configured to display a two-dimensional geometric shape on a screen, a controller configured to detect at least one user input that crosses and divides the two-dimensional geometric shape into multiple portions, detect touches on each of the multiple portions in a sequence, and compare the sequence of the touches on each of the multiple portions with a pre-defined sequence.

In some embodiments, the controller is further configured to unlock a lock screen when the sequence of the touches on each of the multiple portions matches a predefined sequence.

In some embodiments, the two-dimensional geometric shape is one of a circle, a bar, a rectangular, an oval, an ellipse, or an informal two-dimensional shape.

In some embodiments, the controller is further configured to compare a division structure of the two-dimensional geometric shape into multiple portions with a predefined division structure.

In some embodiments, the controller is further configured to store the sequence of the touches on each of the multiple portions for a password.

In some embodiments, each multiple portion includes a point on the respective portion.

In some embodiments, the two-dimensional geometric shape is divided into three portions by two drags.

In some embodiments, at least one of the multiple portions is touched more than one.

In some embodiments, a portion of the multiple portions, being touched is displayed distinctively.

In some embodiments, the user input is a drag.

To address the above-discussed deficiencies, it is a primary object to provide a method and apparatus for receiving a user's input for unlocking a lock screen regardless of an input region on a touch screen.

Further, the present disclosure is to allow a user to enter intuitively and conveniently an input for unlocking a lock screen without depending upon a guide on the screen.

One embodiment of this disclosure may provide a method for operating a lock screen in an electronic device. This method includes receiving a screen dividing touch input from at least one point on a touch screen; receiving a plurality of single touch inputs from the point of receiving the screen dividing touch input; and unlocking the lock screen when the order of receiving the single touch inputs is identical with a predefined sequential order.

Additionally, this method may further include, after the receiving of the screen dividing touch input, defining a plurality of divided regions on the touch screen, based on the screen dividing touch input.

Another embodiment of this disclosure may provide an electronic device for operating a lock screen. This electronic device includes a touch screen configured to receive a touch-based input and to display information thereon; and a control unit configured to receive a screen dividing touch input from at least one point on the touch screen, to receive a plurality of single touch inputs from the point of receiving the screen dividing touch input, and to unlock the lock screen when the order of receiving the single touch inputs is identical with a predefined sequential order.

In this electronic device, the control unit may be further configured to define a plurality of divided regions on the touch screen, based on the screen dividing touch input.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A to 1C are example screens showing typical guides used to unlock the lock screen.

FIG. 2 is a block diagram illustrating the main configuration of an electronic device in accordance with an embodiment of the present disclosure.

FIG. 3 illustrates an example of unlocking a lock screen by receiving a screen dividing touch input and a plurality of single touch inputs in accordance with an embodiment of the present disclosure.

FIG. 4 illustrates an example of displaying a screen dividing touch input and a plurality of single touch inputs on a touch screen in accordance with an embodiment of the present disclosure.

FIG. 5 is a flow diagram illustrating a method for operating a lock screen in an electronic device in accordance with an embodiment of the present disclosure.

FIGS. 6A and 6B illustrates the techniques to determine a divided region corresponding to a user's touch input by using a trigonometric function and rotational transformation or a linear equation in accordance with embodiments of the present disclosure.

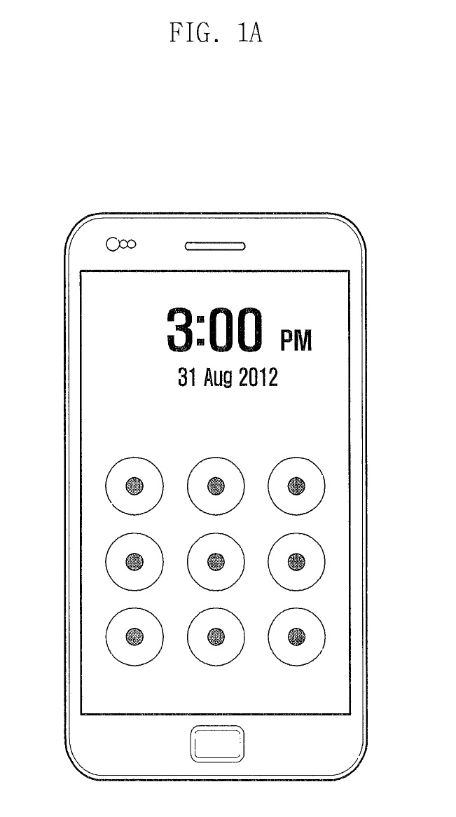

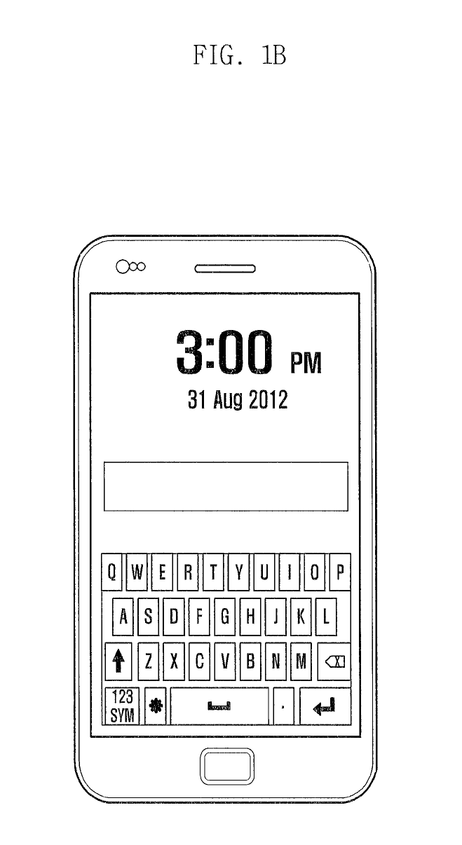

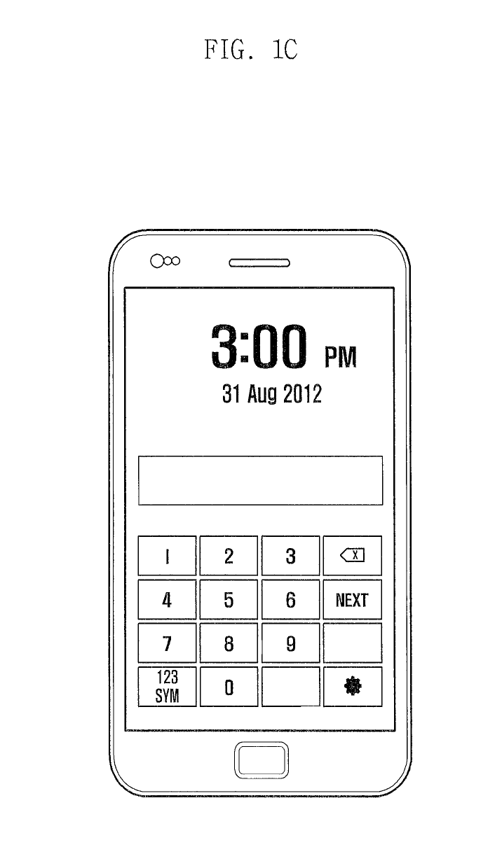

### DETAILED DESCRIPTION

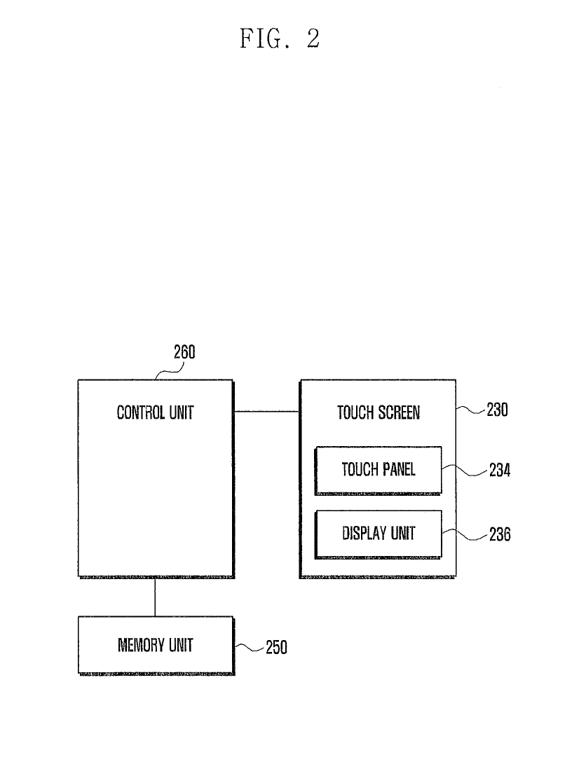

FIGS. 2 through 6B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a touch input” includes reference to one or more of such touch inputs.

FIG. 2 is a block diagram illustrating the main configuration of an electronic device in accordance with an embodiment of the present disclosure. As shown in FIG. 2, the electronic device 200 can include a touch screen 230, a memory unit 250, and a control unit 260.

The touch screen 230 includes a touch panel 234 and a display unit 236. The touch panel 234 detects a user's touch input. The touch panel 234 can be formed of a touch detecting sensor of a capacitive overlay type, a resistive overlay type, an infrared beam type, etc. or a pressure sensor. Alternatively, any other type sensor device capable of detecting contact or pressure of an object can be used for the touch panel 234.

The touch panel 234 detects a user's touch input, creates a sensing signal, and transmits the sensing signal to the control unit 260. This sensing signal contains coordinate data of the detected touch input. In case a user takes a touch-and-drag action, the touch panel 234 creates a sensing signal containing coordinate data of a touch-and-drag path and transmits the sensing signal to the control unit 260.

Particularly, in an embodiment of this disclosure, the touch panel 234 can receive a screen dividing touch input and a single touch input for entering an unlocking pattern. The screen dividing touch input can be a drag input starting from at least one point on the touch screen 230. The single touch input for entering an unlocking pattern can be a plurality of single touch inputs on a plurality of divided regions defined previously by the screen dividing touch input.

The display unit (i.e., screen) 236 can be implemented by a LCD (Liquid Crystal Display), an OLED (Organic Light Emitted Diode), an AMOLED (Active Matrix OLED), or the like. The display unit 236 visually offers a user various types of information such as a menu of the electronic device 200, any input data, function setting information, and the like. Additionally, the display unit 236 can display information about the operating status of the electronic device 200.

Particularly, in an embodiment of this disclosure, the display unit 236 displays a chunk on a screen. The chunk can be of any shapes such as a circle, a bar, a rectangular, an oval, an ellipse, or any informal shapes. Then, the display unit 236 receives drags that cross and divide the chunk into multiple regions. The display unit 236 receives touches on one of the multiple regions in a sequence, and store the sequence of touches as a code. The stored sequence can be used to unlock a screen or an application. Meanwhile, the display unit 236 can be activated in response to a user's turn-on command and then display a predefined lock screen thereon.

The memory unit 250 performs a function to store a variety of programs and data required for the operation of the electronic device 200, and can include a program region and a data region.

The program region can store various default programs such as a program for controlling a general operation of the electronic device 200, an operating system for booting the electronic 200, and the like. Additionally, the program region can store various applications selectively installed by a user, for example, a game application, a social network service application, and the like.

The data region can store various data created during the use of the electronic device 200, such as image data, video data, audio data, phonebook data, and the like. Particularly, in an embodiment of this disclosure, the data region can store information about a plurality of divided regions defined in response to a user's screen dividing touch input, and also store information about the sequential order defined for unlocking the lock screen and to be compared with the order of receiving user's single touch inputs.

The control unit 260 controls a general operation of the electronic device 200. Particularly, in an embodiment of this disclosure, the control unit 260 receives a screen dividing touch input on at least one point of the display unit 236 from the touch panel 234, and then, based on the received screen dividing touch input, defines a plurality of divided regions on the touch screen 230. Additionally, the control unit 260 receives a plurality of single touch inputs on the divided regions from the touch panel 234, and then performs a process of unlocking the lock screen if the order of receiving the single touch inputs is identical with a predefined sequential order.

Further, after the divided regions are defined, the control unit 260 can control the display unit 236 to display thereon the divided regions. Now, an example of graphic user interface associated with a process for unlocking the lock screen by sequentially receiving the screen dividing touch input and the single touch inputs will be described with reference to the drawings.

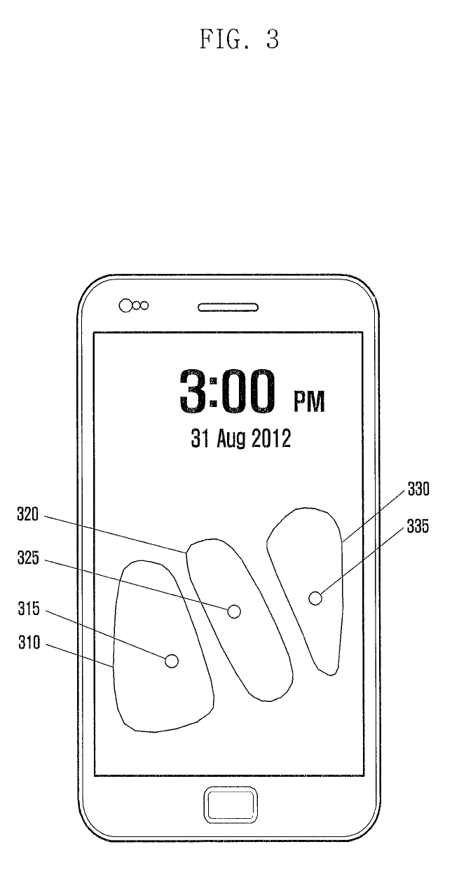

FIG. 3 illustrates an example of unlocking a lock screen by receiving a screen dividing touch input and a plurality of single touch inputs in accordance with an embodiment of the present disclosure.

As illustrated in FIG. 3, a user divides a chunk (including a two dimensional geometrical shape) into multiple regions 310, 320 and 330 by crossing the chunk. After that, the user defines, as the sequence order for unlocking the touch screen, sequential inputs of the first single touch 315 on the first divided region 310, the second single touch 325 on the second divided region 320, the third single touch 335 on the third divided region 330, the fourth single touch 325 on the second divided region 320, and the fifth single touch 315 on the first divided region 310. The touch point is not limited to one fixed point, but can be any places within each region.

In a state where the touch screen is activated but remains in a lock screen, a user can define some divided regions by performing a multi touch input or a multi touch-and-drag input on arbitrary points of the touch screen. As the former case, when a user simultaneously performs a multi touch input on three points 315, 325 and 335, the control unit 260 can recognize this input as the screen dividing touch input. As the latter case, when a user simultaneously performs a multi touch-and-drag input on three regions 310, 320 and 330, the control unit 260 can recognize this input as the screen dividing touch input.

Then, based on such a screen dividing touch input, the control unit 260 can define three regions 310, 320 and 330 as the first divided region, the second divided region and the third divided region, respectively. Particularly, such divided regions can be defined on any region of the touch screen, depending on a user's input.

For example, in a case shown in FIG. 3, if three divided regions can be merely defined by means of a user's touch input regardless of the position of receiving a multi touch input or a multi touch-and-drag input, the control unit 260 can perform the following process of unlocking the lock screen.

A user who has performed a screen dividing touch input can perform sequential single touch inputs on the touch screen so as to enter an unlocking pattern. In an embodiment of this disclosure, the sequence can be defined as the order of touch inputs on the above-discussed divided regions.

In a case shown in FIG. 3, if a user inputs sequentially single touches in the order of points 315, 325, 335, 325 and 315, the control unit 260 can recognize this input as single inputs for entering an unlocking pattern.

Then the control unit 260 can compare such sequential inputs of single touches with a predefined unlocking pattern. In a case shown in FIG. 3, the control unit 260 can determine that sequential touch inputs on the points 315, 325, 335, 325 and 315 are identical with a predefined unlocking pattern, namely, sequential inputs of the first single touch on the first divided region, the second single touch on the second divided region, the third single touch on the third divided region, the fourth single touch on the second divided region, and the fifth single touch on the first divided region.

Like the above case, if the sequence of receiving single touch inputs is identical with a predefined unlocking pattern, the control unit 260 can unlock the lock screen.

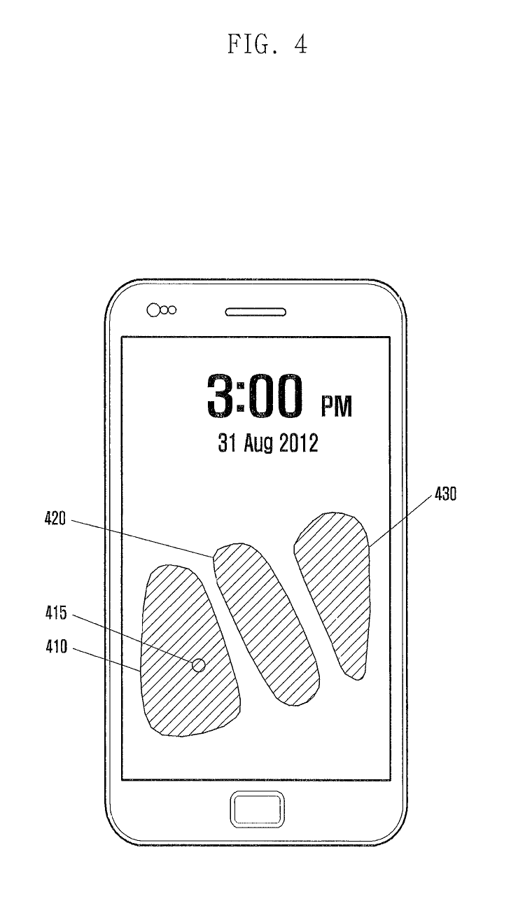

FIG. 4 illustrates an example of displaying a screen dividing touch input and a plurality of single touch inputs on a touch screen in accordance with an embodiment of the present disclosure.

In an embodiment of this disclosure, in order to assist a user in the way of perception, the control unit 260 can control the touch screen 230 to display thereon the positions of receiving the screen dividing touch input and the single touch input.

In a case shown in FIG. 4, if a user performs a simultaneous touch-and-drag input, as the screen dividing touch input, on regions 410, 420 and 430, the control unit 260 can control the display unit 236 to differentially display thereon the positions of receiving the above touch input, namely, the regions 410, 420 and 430.

Additionally, if a user performs a single touch input, as the single touch input for entering pattern information, on a point 415, the control unit 260 can control the display unit 236 to display thereon the point 415.

According to an embodiment of this disclosure, there is no need to display any guide predefined for unlocking the lock screen. However, as shown in FIG. 4, a flexible user interface can be offered such that the screen dividing touch input and the single touch input can be displayed.

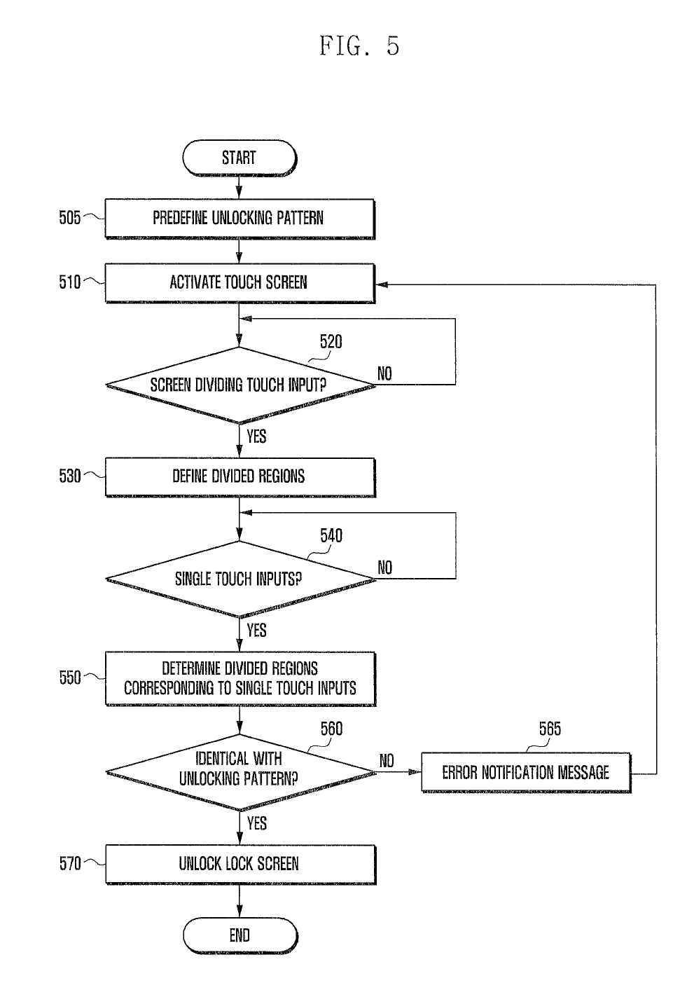

FIG. 5 is a flow diagram illustrating a method for operating a lock screen in an electronic device in accordance with an embodiment of the present disclosure.

Referring to FIG. 5 together with FIG. 2, at operation 505, the control unit 260 can predefine a pattern for unlocking the lock screen. In the above-discussed case, the control unit 260 can predefine, as such an unlocking pattern, sequential inputs of the first single touch on the first divided region, the second single touch on the second divided region, the third single touch on the third divided region, the fourth single touch on the second divided region, and the fifth single touch on the first divided region.

The control unit 260 can define such an unlocking pattern in response to a user's input for directly defining any pattern or selecting a specific one of default patterns.

At operation 510, the control unit 260 can activate the touch screen 230 to enter into a state of the lock screen. In this state, the touch screen 230 can receive a user's input only for unlocking the lock screen.

At operation 520, the control unit 260 can receive a touch input for dividing the screen from any point of the touch screen 230. In the above-discussed case of FIG. 3, when a user performs a multi touch input on points 315, 325 and 335 or a multi touch-and-drag input on regions 310, 320 and 330, the control unit 260 can recognize this input as the screen dividing touch input.

At operation 530, the control unit 260 can define divided regions of the touch screen 230 on the basis of the received touch input. In the above-discussed case of FIG. 3, the control unit 260 can receive, at operation 520, a multi touch input from the points 315, 325 and 335 or a multi touch-and-drag input from the regions 310, 320 and 330, and thereby define, at operation 530, the regions 310, 320 and 330 as the first, second and third divided regions, respectively.

In some embodiments of this disclosure, if any multi touch-and-drag input is received as the screen dividing touch input at operation 520, the control unit 260 can define, at operation 530, the divided regions by using a user's drag shape as it is or by using any boundary between adjacent drag shape.

Particularly, in embodiments of this invention, the divided regions can be defined from any region on the touch screen 230, only based on a user's setting input. Namely, in case the control unit 260 predefines three divided regions as an unlocking pattern at operation 505, and if three divided regions are successfully defined at operation 530 regardless of positions receiving a user's input at operation 520, the control unit 260 can perform a process for unlocking the lock screen.

Thereafter, at operation 540, the control unit 260 can receive user's sequential single touch inputs for entering an unlocking pattern from the touch screen 230. In the above-discussed case of FIG. 3 in which a user inputs sequentially single touches in the order of points 315, 325, 335, 325 and 315, the control unit 260 can recognize this input as single inputs for entering an unlocking pattern.

At operation 550, the control unit 260 can determine which divided regions correspond to positions of the received single touch inputs, respectively. According to embodiments of this disclosure, by using a trigonometric function and rotational transformation or a linear equation, the control unit 260 can determine which one of the divided regions corresponds to the position of each single touch input.

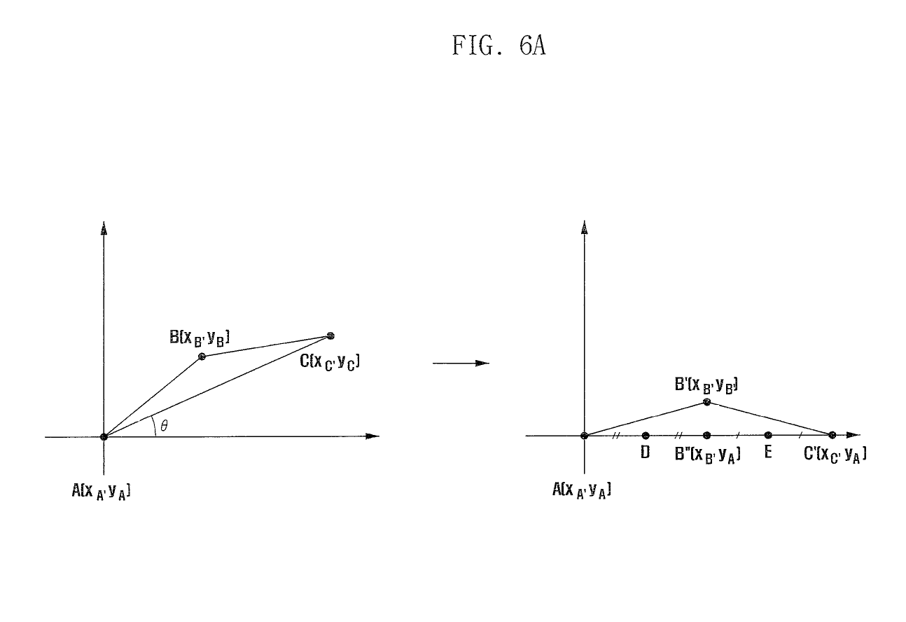

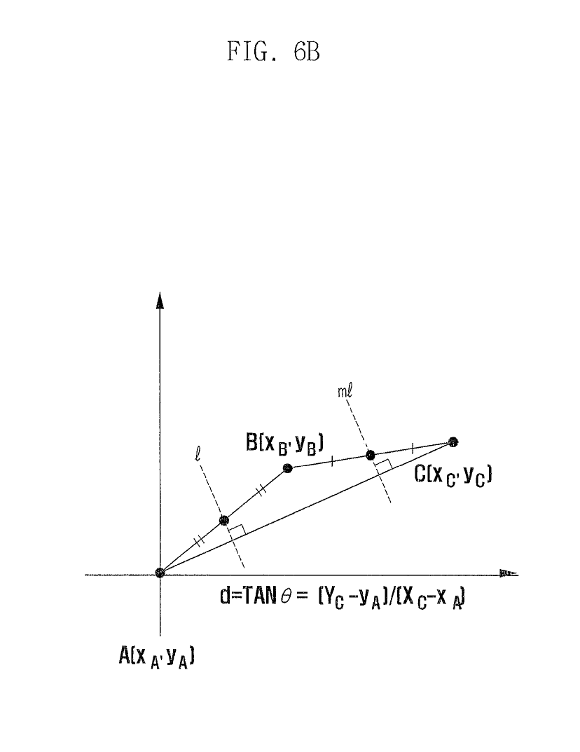

A detailed description about the above determination will be given below with reference to FIGS. 6A and 6B.

Then, at operation 560, the control unit 260 can determine whether the sequence of receiving the single touch inputs is identical with the predefined unlocking pattern.

As discussed above, the unlocking pattern is predefined as the sequence of touch inputs at operation 505. If a user inputs sequentially five single touches in the order of points 315, 325, 335, 325 and 315 as discussed in a case of FIG. 3, the control unit 260 determines at operation 560 whether this sequential order is identical with the predefined unlocking pattern, that is, sequential inputs of the first single touch on the first divided region, the second single touch on the second divided region, the third single touch on the third divided region, the fourth single touch on the second divided region, and the fifth single touch on the first divided region.

If the sequential order of the received single touch inputs is identical with the predefined unlocking pattern, the control unit 260 unlocks the lock screen at operation 570. In contrast, if the sequential order of the received single touch inputs is not identical with the predefined unlocking pattern, the control unit 260 can control the display unit 236 to display an error notification message at operation 565.

FIGS. 6A and 6B are views illustrating the techniques to determine a divided region corresponding to a user's touch input by using a trigonometric function and rotational transformation or a linear equation in accordance with embodiments of the present disclosure.

Specifically, FIG. 6A shows a technique for determination based on a trigonometric function and rotational transformation.

In case a user inputs a multi touch for dividing the screen (e.g., a three-point touch as shown in FIG. 6A), the control unit 260 can obtain the coordinates of three touch points, A(xA, yA), B(xB, yB) and C(xC, yC), and then calculate the length of line segments, |AB|, |BC| and |CA|, each of which has both end points selected from three touch points.

Further, the control unit 260 can determine the gradient of the longest line segment (i.e., gradient d=tan θ=(yC−yA)/(xC−xA)) when the horizontal axis of the screen is set to the x-axis.

Additionally, the control unit 260 can calculate the cosine of an angle θ and the sine of an angle θ from the tangent of an angle θ, and using them, find the coordinates of points B′ and C′ rotated from the touch points B and Con the origin which is set to the touch point A. Here, the origin can be set to a point having the smallest x-coordinate from among the touch points A, B and C.

Then, using a perpendicular foot B″ which is drawn from the rotated point B′ on a line segment AC′, the control unit 260 can find the center D of a line segment AB″ and the center E of a line segment B″C′. Further, the control unit 260 can determine the x-coordinate of the center D, xD, and the x-coordinate of the center E, xE, as boundary points used to define touch regions.

Thereafter, when single touch inputs for entering an unlocking pattern are received from a user, the control unit 260 can find a touch point N(xN, yN) and then calculate a rotated point N″(xN″, yN″) which has a rotation angle θ on the origin A.

In an embodiment of this disclosure, the control unit 260 determines touched regions by comparing the above x-coordinates xD, xE, and xN″. For example, in case of xN″<xD, the control unit 260 can determine that the first divided region is touched. Similarly, in case of xD<xN″<xE or xE<xN″, the control unit 260 can determine that the second or third divided region is touched.

FIG. 6B shows a technique for determination based on a linear equation.

In case a user inputs a multi touch for dividing the screen (e.g., a three-point touch as shown in FIG. 6B), the control unit 260 can obtain the coordinates of three touch points, A(xA, yA), B(xB, yB) and C(xC, yC), and then calculate the length of line segments, |AB|, |BC| and |CA|, each of which has both end points selected from three touch points.

Further, the control unit 260 can determine the gradient of the longest line segment (i.e., gradient d=tan θ=(yC−yA)/(xC−xA)) when the horizontal axis of the screen is set to the x-axis.

Additionally, the control unit 260 can find linear equations of straight lines l and m each of which is perpendicular to a line segment AC and passes through the center of a line segment AB or the center of a line segment BC.

Thereafter, when single touch inputs for entering an unlocking pattern are received from a user, the control unit 260 can determine the position of a touch point N(xN, yN) by substituting it in the linear equations of straight lines l and m.

For example, when the linear equation of a straight line l is y=−(1/d)x+bl and when the linear equation of a straight line m is y=−(1/d)x+bm, the position of a touch point N(xN, yN) can be determined as follows:
1) if y_{N}<−(1/d)x_{N}+bₗ, a touch point N is located at the first divided region which is under a straight line l;
2) if y_{N}>−(1/d)x_{N}+bₗ, and if y_{N}<−(1/d)x_{N}+bₘ, a touch point N is located at the second divided region which is between a straight line l and a straight line m; and
3) if y_{N}>−(1/d)x_{N}+bₘ, a touch point N is located at the third divided region which is over a straight line m.

As fully discussed hereinbefore, embodiments of this disclosure can provide techniques to unlock the lock screen through a simple user input without any guide displayed on the screen. Further, two or more divided regions to be used for unlocking the lock screen can be defined freely depending on a user's touch input. Therefore, techniques disclosed herein may allow a user to enter intuitively and conveniently an input for unlocking the lock screen.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for operating a lock screen in an electronic device, the method comprising:
displaying a two-dimensional geometric shape on a screen;
receiving at least one user input that crosses and divides the two-dimensional geometric shape into multiple portions;
receiving touches on each of the multiple portions in a sequence; and
comparing the sequence of the touches on each of the multiple portions with a pre-defined sequence.

2. The method of claim 1, further comprising:
unlocking a lock screen when the sequence of the touches on each of the multiple portions matches a predefined sequence.

3. The method of claim 1, wherein the two-dimensional geometric shape is one of a circle, a bar, a rectangular, an oval, an ellipse, or an informal two-dimensional shape.

4. The method of claim 1, further comprising:
comparing a division structure of the two-dimensional geometric shape into multiple portions with a predefined division structure.

5. The method of claim 1, further comprising:
storing the sequence of the touches on each of the multiple portions for a password.

6. The method of claim 4, wherein each multiple portion includes a point on the respective portion.

7. The method of claim 1, wherein the two-dimensional geometric shape is divided into three portions by two drags.

8. The method of claim 1, wherein at least one of the multiple portions is touched more than one.

9. The method of claim 1, wherein a portion of the multiple portions, being touched is displayed distinctively.

10. The method of claim 1, wherein the user input is a drag.

11. An electronic device for operating a lock screen, the electronic device comprising:
a touch screen configured to display a two-dimensional geometric shape on a screen; and
a controller configured to:
detect at least one user input that crosses and divides the two-dimensional geometric shape into multiple portions;
detect touches on each of the multiple portions in a sequence; and
compare the sequence of the touches on each of the multiple portions with a pre-defined sequence.

12. The electronic device of claim 11, wherein the controller is further configured to unlock a lock screen when the sequence of the touches on each of the multiple portions matches a predefined sequence.

13. The electronic device of claim 11, wherein the two-dimensional geometric shape is one of a circle, a bar, a rectangular, an oval, an ellipse, or an informal two-dimensional shape.

14. The electronic device of claim 11, wherein the controller is further configured to compare a division structure of the two-dimensional geometric shape into multiple portions with a predefined division structure.

15. The electronic device of claim 11, wherein the controller is further configured to store the sequence of the touches on each of the multiple portions for a password.

16. The electronic device of claim 11, wherein each multiple portion includes a point on the respective portion.

17. The electronic device of claim 11, wherein the two-dimensional geometric shape is divided into three portions by two drags.

18. The electronic device of claim 11, wherein at least one of the multiple portions is touched more than one.

19. The electronic device of claim 11, wherein a portion of the multiple portions, being touched is displayed distinctively.

20. The electronic device of claim 11, wherein the user input is a drag.
